(19) United States
(12) Patent Application Publication
(10) Pub. No.: US 2008/0253832 A1
(43) Pub. Date: Oct. 16, 2008

(54) Non-interfering spring operated button assembly

(76) Inventor: Tim O'Connell, Chico, CA (US)

Correspondence Address: Tim O'Connell, 10 Parkside Court, Chico, CA, 95928, US

(21) Appl. No.: 11/787,153

(22) Filed: Apr. 13, 2007

(51) Int. Cl. F16B 7/10

(52) U.S. Cl. 403/109.3

(57) ABSTRACT

A spring operated button assembly for use with telescoping thick-walled tubes or adjacent planar surfaces wherein the entire spring assembly may be contained within a pocket to allow movement of surfaces past the spring button assembly without interference.

### CROSS-REFERENCE TO RELATED APPLICATION

This application claims priority to U.S. Provisional Patent Application No. U.S. 60/790,051 filed Apr. 13, 2006, the entire disclosure of which is incorporated herein by reference.

### BACKGROUND OF THE INVENTION

1. Field of the Invention

The invention relates generally to spring operated buttons, in particular, to spring operated buttons used in telescoping tubes.

2. Description of the Related Art

Telescoping tubes are common and have a variety of uses. There are numerous ways to fix the tube sections in relationship to each other. Threaded compression members may be used to tighten a friction device in extendable handles for dusters and light bulb changers. Solid pins may be inserted through adjacent surfaces to fix them in relationship with each other. Spring operated buttons (also called snap-buttons) in many shapes and forms are used to index surfaces and tubes in devices such as crutches (Kelly—U.S. Pat. No. 5,139,040), table legs (Pehta—U.S. Pat. No. 6,920,834), and rolling luggage handles (Kuo—U.S. Pat. No. 6,609,271). A recently developed button (Obitts—U.S. Pat. No. 6,079,894) references a wide variety of patents with related art. Many of these buttons are manufactured by Valco Valley Tool and Die, Inc. Their catalog shows many types of spring and snap buttons for numerous applications mounted to both the interior and exterior of the tubing surfaces. The Valco Valley Tool and Die Catalog is on the internet at http://www.valcocleve.com/catalog.htm

Telescoping tubing is typically made of relatively thin material, most commonly aluminum, steel, or plastic. Because of the thin walls, there is not enough space within the thickness of the wall to install a spring operated button. Therefore, all of the spring operated buttons in these types of devices are mounted either on the inside or outside surfaces of one of the tubes with the button passing through a hole in that tube (see assorted mounting options in the Valco catalog). The hole provides lateral mechanical support to the button and makes the button available to index a hole or protrusion in another tube or surface on the opposite side of the tube surface to which the spring operated button is attached. This configuration of the spring operated button causes any adjacent tube or surface to be blocked from sliding past the point where the spring operated button is mounted because the body of the spring operated button interferes with the path of the tube (Parsons—U.S. Pat. No. 5,797,797 and McMullin—U.S. Pat. No. 2,980,456). For this reason, existing telescoping tubes are either limited to two sections or designed so that additional telescoping sections are progressively shorter to allow room to affix sequential spring operated buttons in a section where a telescoping tube will not need to pass.

Thus, there is a need for a device that will allow telescoping tubes to be made of more than two sections with the ability for the sections to freely slide past the spring operated button assemblies.

There is also a need for a device that will allow multiple sections of telescoping tube to be connected without the need for the tubes to be progressively shorter in length.

### 3. SUMMARY OF THE INVENTION

The invention is a spring operated button assembly for interlocking or fixing telescoping tubes or multiple adjacent surfaces in relationship to each other. The spring operated button assembly is entirely contained in a pocket within the wall of the tube or surface. The spring operated button can extend and index a hole or protrusion in an adjacent surface and then depress completely into the surface to which it is mounted, without the spring operated button assembly interfering with any other surfaces. This allows an unlimited number of tubes or surfaces to be connected or sandwiched together regardless of their length, without interference from the spring operated button because the tube sections can slide past the site where the spring operated button is mounted.

Another variation of the invention has a button on both sides of the flat spring which would cause one of the buttons to extend out past the surface on one side of the wall when the button on the other side of the flat spring was depressed. This would allow such things as staged extensions and logical control of surfaces such that one surface might be locked if another surface was moved.

The invention is advantageous in that it permits a telescoping tube to have as many sections as desired; all tubes can be of the same length; and tubes can extend out either end. Another advantage of the invention is that multiple planar surfaces can be connected or sandwiched together to move in any direction without interference from a spring operated button mounted in an adjacent surface.

In addition, advancing technologies have resulted in the development of new materials for the construction of telescoping tubing including fiber composites such as carbon fiber. When these materials are used, the tube walls need to be thicker in order to provide the necessary strength. A tube currently in use has walls that are ¼″ thick. The device of the invention will work well with these thicker-walled tubes, as it is completely recessed within the wall of the tube.

### 4. BRIEF DESCRIPTION OF THE DRAWINGS

FIG. 1 is a perspective view of a typical application of the spring button assembly viewed through a cut out section in a set of three thick walled telescoping tubes.

FIG. 2 is a cutaway view of a spring button assembly with the button extended through a hole in an adjacent surface unidirectionally locking the surfaces together without interfering with the lower surface.

FIG. 3 is a cutaway view of the same spring button assembly shown in FIG. 2 with the spring button assembly fully depressed into a pocket within a center plane or tube allowing independent motion of all three planes or tubes.

FIG. 4 is a cutaway view of a double button spring assembly locking the middle and lower planes together while allowing movement of the upper plane or tube.

FIG. 5 is a cutaway view of the same double button spring assembly shown in FIG. 4 locking the middle and upper planes together while allowing movement of the lower plane or tube.

### 5. DETAILED DESCRIPTION OF THE PREFERRED EMBODIMENTS

This invention is a spring operated button assembly which is mounted within a pocket formed in the wall of a tube or in a planar surface. The spring operated button extends out from the spring surface to index an adjacent hole or protrusion in the traditional fashion, but the entire spring operated button assembly is completely contained in a formed pocket within the width of the wall to which it is mounted when depressed. This allows another tube or planar surface on the opposite side from where the spring operated button extends to adjacently slide past the spring button mounting site without interference.

The spring operated button assembly includes a flat spring, at least one button, a pocket within the wall of a tube or within a planar surface, and rivets, screws, adhesive, or other means for attaching the spring to the surface of the pocket. The spring and button may be made of metal such as steel, plastic, composite or other materials. The tubing or planar surface may be of any material or thickness as long as a pocket of sufficient depth to conceal the spring mounted button assembly may be formed.

The spring mounted button is mounted inside a pocket within a planar surface instead of on a planar surface, thereby allowing the entire spring operated button assembly to be retained within the confines of the planar surface. The spring operated button has one fixed end (attached via rivets, screws, adhesive, or other means), and one sliding end allowing the spring operated button to mechanically control an adjacent surface without the support of a hole in the same surface to which the spring operated button is attached. The spring mounted button assembly may include more than one button. For example, two or more buttons may be placed on opposite sides so that the depression of a button on one side of a plane would cause extension of the opposing button on the other side of the plane.

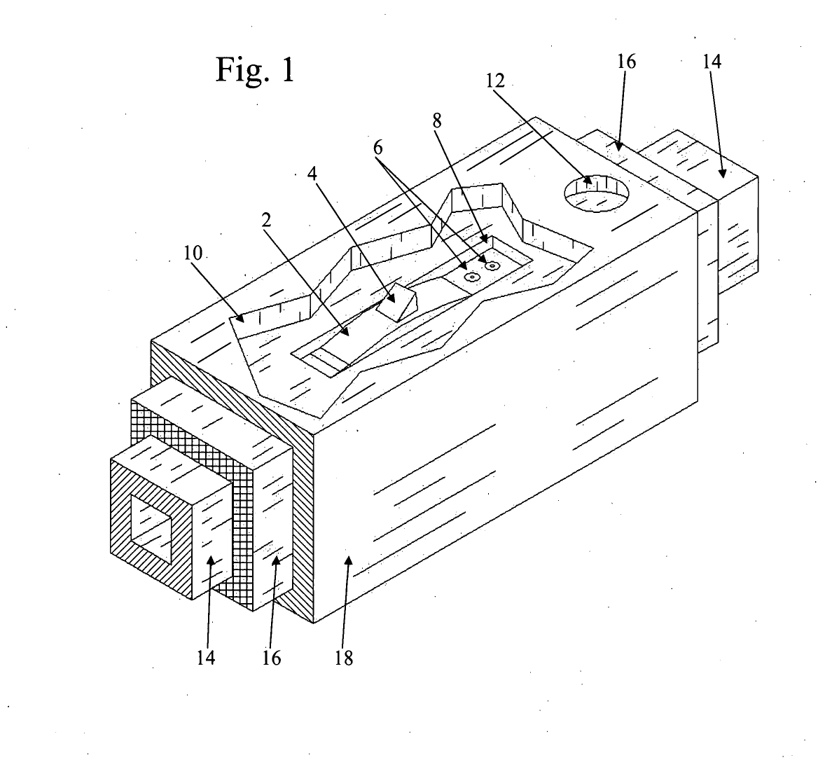

FIG. 1 shows a typical embodiment of the invention in a set of three telescoping thick walled tubes consisting of an inner tube 14, a middle tube 16 and an outer tube 18. A section of outer tube 18 has been removed 10 to show the components of the spring button assembly. In this embodiment flat spring 2 is mounted in formed pocket 8 and secured at one end with two rivets 6. Button 4 is attached to flat spring 2 with rivets, adhesive, a weld or other means and is forced upward against the inner surface of outer tube 18 by the spring 2. Because the spring 2 is mounted in a pocket 8 all of button 4 fits within the confines of the planar surfaces of the center tube 16 and allows free motion of all three tubes in relation to each other. This embodiment includes a hole 12 through the outer tube 18 which acts as a limiting stop. When outer tube 18 extends to the point where hole 12 aligns with button 4, button 4 is forced upwards through hole 12 and outer tube 18 is prevented from traveling any further in relationship to middle tube 16. In this embodiment button 4 is ramped on one side which allows hole 12 to forcibly depress button 4 back into pocket 8 if the direction of travel of outer tube 18 is reversed.

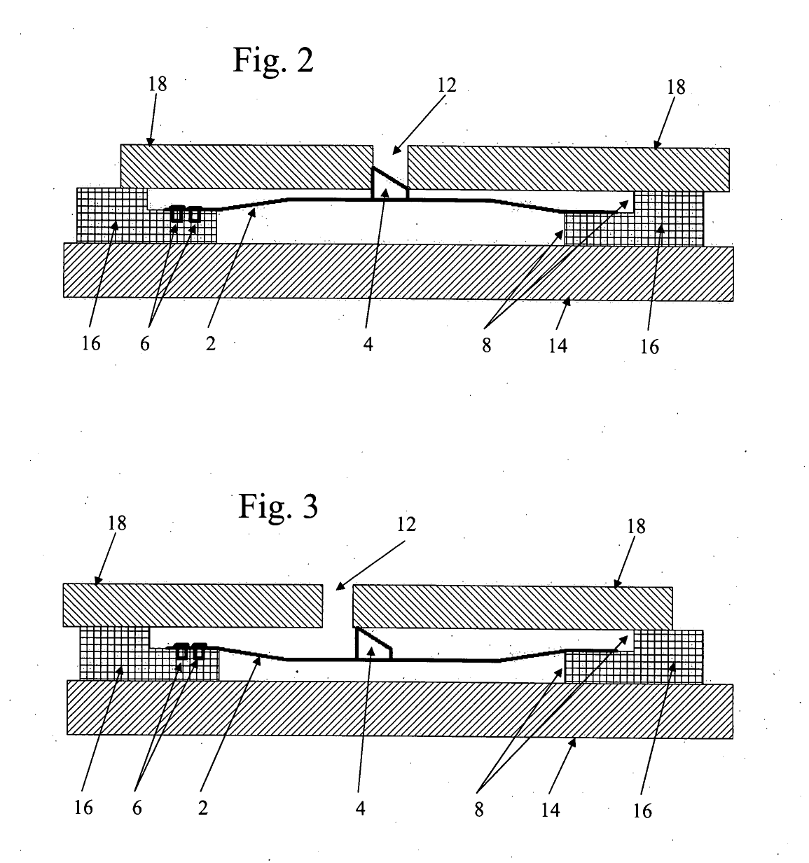

FIG. 2 shows a side cut-away view of a portion of FIG. 1 showing the upper portion of the three telescoped thick-walled tubes (outer 18, middle 16, and inner 14). A known tube has walls ¼″ thick. A pocket 8 is milled in the wall of the middle tube 16 completely through the tube, with a shelf at each end of the pocket produced by extending the pocket with a cutter positioned to cut only half way through the tube. A flat spring 2 is positioned between the shelves and attached at one end with rivets, screws, adhesive, or other method of affixing the spring to the shelf 6. The other end of the spring is not affixed so that it can slide along the shelf as the spring flexes. A button 4 is attached to the spring 2 with rivets, adhesive, a weld or other means so that it extends up past the upper plane of the middle tube 16 when free but may be depressed completely within the width of the middle tube 16. The button 4 may be configured in a variety of ways, including angled or ramped in either direction, convex, or straight on top.

FIG. 3 shows the same cut-away section as FIG. 2. In this figure the outer tube 18 has moved to the left which has caused the hole 12 in the outer tube 18 to push on the ramped section of the button 4 forcing the button inward and depressing the button 4 and spring 2 into the pocket 8. This allows the outer tube 18 and middle tube 16 to move independent of each other. None of these actions interfere with the free motion of the inner tube 14 because the spring mechanism 2 and button 4 are fully contained within the width of the middle tube 16. Any movement of the outer tube 18 to the right will cause it to be engaged with the middle tube 16, either stopping the outer tube 18 from continuing in that direction or moving the middle tube 16 in conjunction with the outer tube.

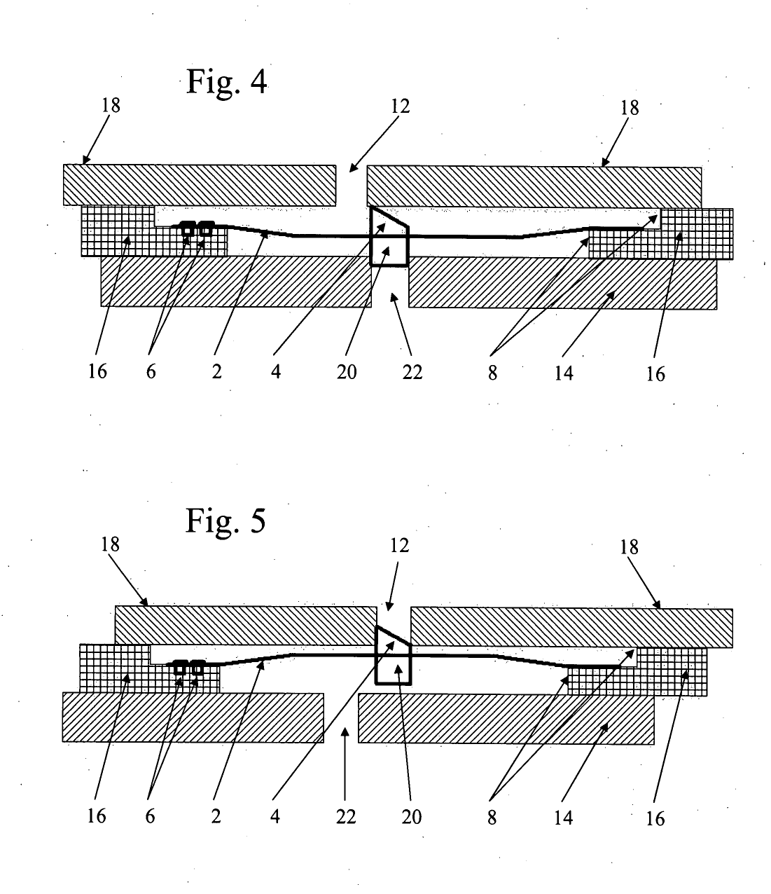

FIG. 4 shows a cut-away of another embodiment of the invention having two buttons on opposite sides of the spring attached with rivets, adhesive, a weld or other means. The buttons may be of any configuration to provide different results. In this example, it is desired that the middle tube 16 and the inner tube 14 should be locked in relationship with each other until the outer tube 18 has extended to a certain position. The outer tube 18 is moving to the right but has not reached the desired limit of travel. The wall of the outer tube 18 is depressing the ramped button 4 into the pocket 8 which simultaneously pushes the straight button 20 out the bottom of the pocket 8 into a hole 22 in the inner tube 14, locking them together.

FIG. 5 shows the same cut-away as FIG. 4 after the outer tube 18 has moved to the right to the desired limit of travel in relation to middle tube 16. The outer tube hole 12 is indexed over the ramped spring button 4 allowing the spring 2 to push the ramped button 4 outward into the hole 12 and locking the outer tube 18 and middle tube 16 together. The spring 2 simultaneously pulls the lower button 20 out of the hole in the inner tube 22, unlocking the middle tube 16 from the inner tube 14 and allowing the middle tube 14 to move independently of the other tubes.

Many combinations of the spring operated button assembly of the invention may be used to provide different kinds of relational motion between tubes and planes for a variety different uses.

I claim:

1. A spring-operated button assembly, comprising;
a flat spring;
at least one button attached to said spring; and
means for attaching said spring in a pocket within a wall of a tube or planar surface;
wherein said spring with said attached button is mounted inside a pocket within a wall of a tube or planar surface.

2. The spring-operated button assembly of claim 1, wherein said spring has a fixed end and a sliding end, and further, wherein said fixed end is attached to said wall and said sliding end is not attached.

3. The spring-operated button assembly of claim 1, wherein said button is angled on one side.

4. The spring-operated button assembly of claim 1, wherein said button comprises two buttons, and further, wherein said two buttons are attached on opposite sides of said spring.

5. The spring-operated button assembly of claim 1, wherein said tube is one tube of a set of telescoping tubes.

6. The spring-operated button assembly of claim 1, wherein said spring-operated button assembly is completely contained within the pocket of the wall to which it is attached, when said button is depressed.
